(19) United States
(12) Patent Application Publication
(10) Pub. No.: US 2014/0197269 A1
(43) Pub. Date: Jul. 17, 2014

(54) CORRECTION TAPE DISPENSER

(71) Applicant: Hyeon Mo Yuh, Incheon (KR)

(72) Inventor: Hyeon Mo Yuh, Incheon (KR)

(73) Assignee: SEJUL CORP., Seoul (KR)

(21) Appl. No.: 14/345,794

(22) PCT Filed: Jul. 24, 2012
(86) PCT No.: PCT/KR2012/005886

§ 371 Date: Mar. 19, 2014

(30) Foreign Application Priority Data
Sep. 19, 2011 (KR) 10-2011-0094264

(51) Int. Cl. B43L 19/00; B43K 23/08

(52) U.S. Cl. CPC B43L 19/00; B43K 23/08
USPC 242/590

(57) ABSTRACT

Disclosed is a dispenser used to correct an error on a paper sheet written with a writing implement inerasable by a rubber eraser, such as a ball-point pen. The dispenser has a cylindrical refill casing rotatable by 360° inside the housing so that it can be used at any angle regardless of an orientation. The dispenser can be conveniently used in a handheld state regardless of an orientation during the use. Since the cylindrical refill casing is retractable into and extractable from the inside of the housing, the refill casing can be retracted into the inside of the housing when the dispenser is not used. Therefore, it is possible to protect the refill casing from external pollution, damage, and the like.

### TECHNICAL FIELD

The present invention relates to a correction tape dispenser, and more particularly, to a dispenser used to correct an erroneous character or the like written with a wring implement inerasable by a rubber eraser, such as a ball-point pen.

### DESCRIPTION OF THE RELATED ART

In general, an erroneous character written with a pencil can be erased using a rubber eraser. However, an erroneous character written with a ball-point pen or the like is corrected by masking the erroneous character using a correction tape dispenser and rewriting over the masking.

That is, the correction tape dispenser is used to correct an error on a paper sheet during documentation such as handwriting or typing.

Typically, the correction tape is formed by coating an opaque white masking material (so-called “white”) on a film roll made of a synthetic resin. Most of the cases, the correction tape is wound around a rill inside the dispenser.

For example, the correction tape has a band-like film having a width of, approximately, 5 mm and a thickness of, approximately, 50 to 60 μm as a basic material and a white opaque masking layer coated on the film. As the opaque masking layer is separated from the film and is transferred, an erroneous portion such as a character and a picture written on a recording medium such as a paper sheet can be corrected.

Such a correction tape dispenser includes: a housing held by one hand during the use; a supply rill that supplies the wound correction tape; a ribbon guide installed in a tip of the casing to guide the correction tape; and a recovery rill that recovers the correction tape after the use. The supply rill and the recovery rill mesh with each other using a gear unit to rotate in opposite directions to wind and unwind the correction tape.

Therefore, as the tip of the ribbon guide is placed onto a surface of the sheet, and the housing is pushed to a certain direction with a pressure, the tip of the ribbon guide causes the correction tape to abut on the surface of the sheet, and the masking material coated on the correction tape is transferred and remains on the surface of the sheet.

The correction tape after the masking material is removed continuously rotates around the tip of the ribbon guide and is wound around the recovery rill. Accordingly, the supply rill also rotates due to the meshing of the gear, so that the new correction tape can be continuously supplied.

However, it is necessary to push the correction tape dispenser while the tip of the ribbon guide is aligned along an erroneous character on the surface of the sheet by holding the housing. This is cumbersome and inconvenient.

In order to address such a problem, a discussion has been made for a dispenser having a ribbon guide 110 rotatable right and left inside the housing 100 as illustrated in FIG. 6. In this technique, a rotation range of the ribbon guide is limited to 10° to 15°. Therefore, it is not sufficient to address cumbersomeness and inconvenience during the use.

### SUMMARY

In view of the aforementioned problems, there is a need for a correction tape dispenser having a cylindrical refill casing rotatable by 360° inside the housing so that it can be used at any angle regardless of an orientation. In addition, the correction tape dispenser can be conveniently used in a handheld state regardless of an orientation during the use.

Furthermore, there is a need for a correction tape dispenser having a cylindrical refill casing retractable into and extractable from the inside of the housing, so that the refill casing can be retracted into the inside of the housing when the dispenser is not used. Therefore, it is possible to protect the refill casing from external pollution, damage, and the like.

According to an aspect of the invention, there is provided a correction tape dispenser used to correct an error on a sheet during documentation such as handwriting or typing, including: a housing having a dispensing hole in a front end; a cap coupled to a rear end of the housing; and a cylindrical refill casing coupled rotatably inside the housing and configured to house a supply rill and a recovery rill meshing with each other using a gear unit, and a ribbon guide for guiding a correction tape.

The refill casing is configured to maintain a certain interval from an inner wall of the housing and is supported by a shaft receptacle provided in a center of an inner surface of the cap using a shaft provided in a center of a rear end of the refill casing so as to be rotatable by 360°.

In the correction tape dispenser described above, the shaft receptacle of the cap may include a shaft receptacle casing that receives the shaft of the refill casing having a wedge shape and catches the rear end of the shaft, and a shaft receptacle groove that supports a wedge portion of the shaft and serves as a rotation support point of the shaft during rotation of the refill casing.

In the correction tape dispenser described above, a pair of guide holes having a spiral shape may be formed around an outer circumferential surface of the housing, and a pair of guide pins inserted into the guide holes to move along the guide holes may be formed on an inner circumferential surface of the cap such that the ribbon guide provided in the front end of the refill casing is retractable into and extractable from the housing as the cap moves forward and backward. As a result, it is possible to protect the refill casing, particularly, the ribbon guide provided in the tip of the refill casing, from external pollution, damage, and the like.

The correction tape dispenser according to an embodiment of the invention has the following advantages.

First, since the refill casing rotates inside the housing by 360°, it is possible to conveniently use the dispenser at any angle regardless of an orientation while a user keeps holding the housing.

Second, the refill casing can be extracted by turning the cap when the dispenser is used. Meanwhile, the refill casing can be housed in the housing by turning the cap when the dispenser is not used. Therefore, it is possible to protect the refill casing from external pollution, damage, and the like. This advantageously provides convenience in safekeeping and handling.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view illustrating a correction tape dispenser according to an embodiment of the invention;

FIG. 2 is another exploded perspective view illustrating the correction tape dispenser according to an embodiment of the invention;

FIG. 3 is a cross-sectional view illustrating the correction tape dispenser according to an embodiment of the invention;

FIG. 4 is a perspective view illustrating a state that a refill casing is housed in the correction tape dispenser and a state that the refill casing is extracted from the correction tape dispenser according to an embodiment of the invention;

FIG. 5 is a perspective view illustrating a 360° rotation state of the refill casing in the correction tape dispenser according to an embodiment of the invention; and

FIG. 6 is a perspective view illustrating a correction tape dispenser of the related art.

### DETAILED DESCRIPTION

Hereinafter, the present invention will be described in detail with reference to the accompanying drawings.

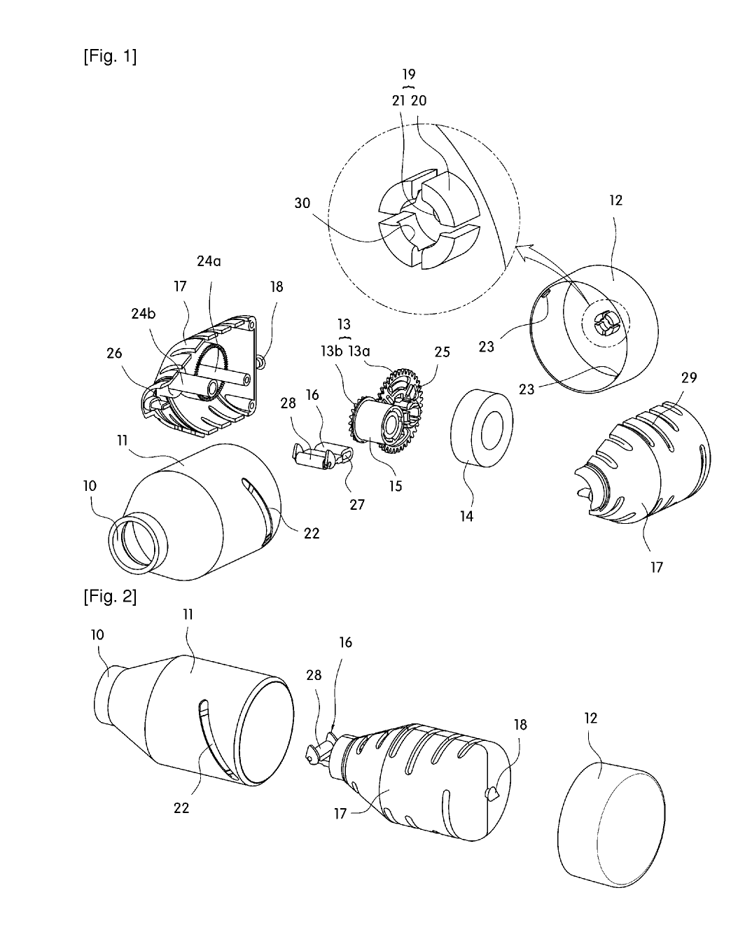

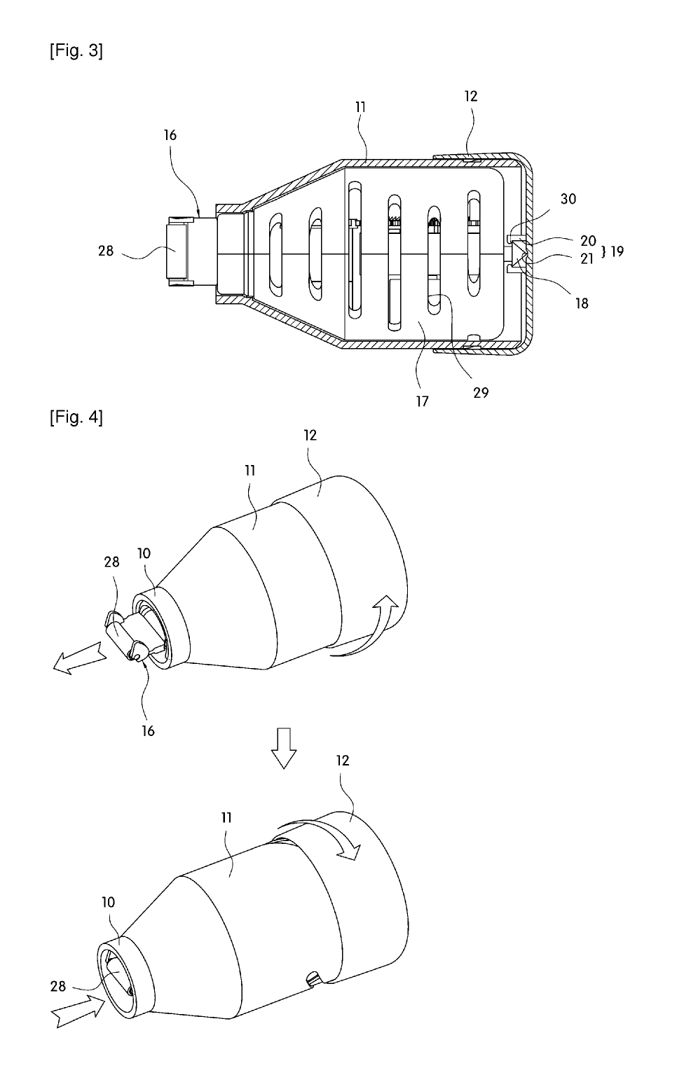

FIGS. 1 and 2 are perspective views illustrating the correction tape dispenser according to an embodiment of the invention, and FIG. 3 is a cross-sectional view illustrating the correction tape dispenser according to an embodiment of the invention.

The correction tape dispenser is used to correct an erroneous character inerasable with a rubber eraser during documentation such as handwriting or typing. Referring to FIGS. 1 to 3, the correction tape dispenser includes a refill casing 17 rotatable by 360° inside a housing 11. Using such a refill casing 17, the correction tape dispenser can be conveniently used without a change in a handheld state regardless of an orientation.

For this purpose, the housing 11 has a cylindrical shape having a front end where a dispensing hole 10 is formed and an opened rear end.

The front side of the housing 11 is tapered to provide an easy holding feeling. The tapered shape is formed by reducing an outer diameter toward the front end side. As a result, a user can use the dispenser by comfortably holding the tapered portion.

Here, the dispensing hole 10 refers to a sort of inlet/outlet port where a ribbon guide 16 of the refill casing 17 enters or exits. The opened rear end of the housing body is finished by a cap 12 described below.

The cap 12 is a member coupled to the rear end of the housing 11. The cap 12 is coupled coaxially with the housing body by surrounding an outer circumference of the housing body so that it can rotate with respect to its axis line around the housing body.

The cap 12 is provided with a shaft receptacle 19 as a means for supporting the refill casing 17 rotatable by 360°. In this case, the shaft receptacle 19 serves as a rotation support when the refill casing 17 rotates.

For this purpose, the shaft receptacle 19 includes a shaft receptacle casing 20 having a circular body protruding from a center portion of the inner surface of the cap 12 and a shaft receptacle groove 21 hollowed in a center of the bottom of the shaft receptacle casing 20, that is, in the center of the inner surface of the cap 12.

In addition, the shaft receptacle 19 has a protrusion 30 protruding to the inner side around the periphery of the end of the shaft receptacle casing 20. In this case, the protrusion 30 serves as a catch that catches a rear end of a shaft 18 of the refill casing 17 inserted into the inside of the shaft receptacle casing 20.

Here, four openings are provided around the shaft receptacle casing 20 to facilitate installation or removal of the refill casing 17 by pushing or pulling the shaft 18 of the refill casing 17 with a weak force when the correction tape is replaced or the like.

In addition, the shaft receptacle groove 21 receives a tip of the shaft 18 having a wedge shape and serves as a rotation support point of the shaft 18 when the refill casing rotates.

The refill casing 17 having a cylindrical shape is installed rotatably by 360° inside the housing.

The refill casing 17 is an assembly type including a pair of parts that can be assembled or disassembled along the axis line direction. In this case, the refill casing 17 may be assembled or disassembled using a locking structure by locking or unlocking a protrusion and a hole on facing surfaces of the parts.

The refill casing 17 has a plurality of slots 29 formed around its wall body for reducing a weight. In addition, similar to the housing 11, in order to match the shape of the housing, a front side of the refill casing 17 is tapered such that an outer diameter is reduced toward the front end where the ribbon guide 16 is installed.

The shaft 18 has a wedge-shaped tip formed in the center of the rear end of the refill casing 17. The shaft 18 is inserted to the inside of the shaft receptacle 19 of the cap 12, so that the refill casing 17 is locked and coupled to the cap 12 to form an integrated structure, and the refill casing 17 can rotate with respect to the shaft 18.

Accordingly, the refill casing 17 is coaxially arranged in the inside of the housing at a certain interval from the inner wall of the housing 11, for example, approximately 0.25 mm. In addition, the shaft 18 of the rear side is supported by the shaft receptacle 19 formed in the center of the inner surface of the cap 12 so that the refill casing 17 can rotate by 360°.

Meanwhile, the refill casing 17 includes a supply rill 14 for supplying the correction tape, a recovery rill 15 for recovering the correction tape, and a ribbon guide 16 for guiding the correction tape.

The supply rill 14, the recovery rill 15, and the ribbon guide 16 are installed in the refill casing 17 altogether while they are supported by the inner side of the refill casing 17. The supply rill 14 and the recovery rill 15 rotate in synchronization while they mesh with a gear unit 13 in order to wind or unwind the correction tape. In this case, the correction tape is unwound from the supply rill 14, changes a direction via the ribbon guide 16, and is then wound around the recovery rill 15.

More specifically, inside the refill casing 17, a pair of rill shafts 24a and 24b extending in a direction perpendicular to the axis line are formed in front and rear sides. Out of a pair of rill shafts 24a and 24b formed in this manner, the supply gear 13a having a boss 25 is installed in the rill shaft 24a arranged in the rear side, and the supply rill 14 is coupled to the boss 25 of the supply gear 13a. In addition, the recovery rill 15 integrated with the recover gear 13b is installed in the rill shaft 24b arranged in the rear side.

The supply gear 13a and the recovery gear 13b mesh with each other, and they can be rotated in synchronization by virtue of a transmission effect based on such gear-meshing.

A ribbon guide shaft 26 is formed in the front end side of the inside of the refill casing 17. In this case, the ribbon guide shaft 26 is inserted into a ribbon guide hole 27 formed in the rear end of the body of the ribbon guide 16.

That is, the ribbon guide 16 can be supported by coupling the ribbon guide hole 27 of the rear end to the ribbon guide shaft 26 of the refill casing 17.

A ribbon guide roll 28 freely rotatable by contact with the correction tape is installed in the front end of the ribbon guide 16. Accordingly, the correction tape is pressed between the rotating ribbon guide roll 28 and the surface of the paper sheet. As a result, the opaque masking material coated on the correction tape is attached to the surface of the paper sheet and remains thereon.

In particular, according to the present invention, the ribbon guide 16 provided in the front end of the refill casing 17 can be retracted into the inside of the housing 11 when the dispenser is not used. In addition, the ribbon guide 16 can be extracted to the outside through the dispensing hole 10 when the dispenser is used.

For this purpose, a pair of guide holes 22 are formed symmetrically in both sides on the outer circumferential surface of the housing 11 along the length direction of the housing in a spiral shape. Matching with the guide holes 22, a pair of guide pins 23 facing each other are formed to protrude on both sides of the inner circumferential surface of the cap 12. In this case, each guide pin 23 is inserted into each guide hole 22 such that they can move along the holes 22.

Accordingly, as illustrated in FIG. 4, as the cap 12 rotates in a certain direction (for example, clockwise) and moves forward, the entire refill casing 17 integrated with the cap 12 moves forward accordingly. As a result, the ribbon guide 16 formed in the front end of the refill casing 17 is extracted to the outside from the housing 11.

In contrast, as the cap 12 rotates reversely (for example, counterclockwise) and moves backward, the refill casing 17 moves backward along with the cap 12. Accordingly, the ribbon guide 16 extracted from the housing 11 can be retracted into the inside of the housing 11. As a result, it is possible to prevent the ribbon guide 16 and the correction tape installed therein from being exposed externally. Therefore, it is possible to protect the refill casing from pollution, damage, and the like.

A description will now be made for a method of using the correction tape dispenser configured as described above.

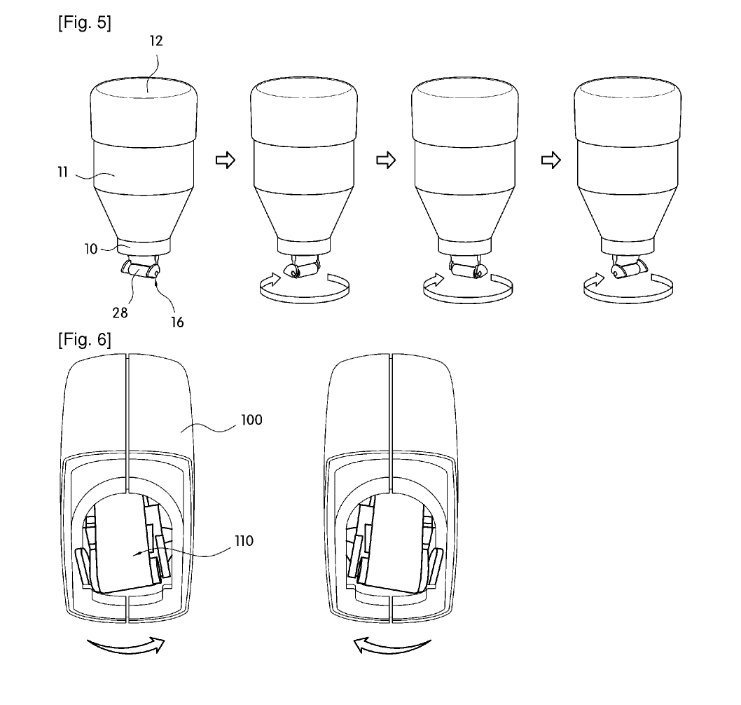

FIG. 5 is a perspective view illustrating a 360° rotation state of the refill casing in the correction tape dispenser according to an embodiment of the invention.

As illustrated in FIG. 5, the cylindrical refill casing 17 that houses the supply rill 14, the ribbon guide 16, and the recovery rill 16 where the correction tape is stretched is installed rotatably by 360° while it is supported by the shaft 18 of the rear end inside the housing 11.

Therefore, as a user holds the housing 11 on one hand and directly places the ribbon guide 16 onto the surface of the paper sheet to correct an error or the like during documentation such as handwriting or typing, the entire refill casing 17 of the ribbon guide 16 freely rotates, and an orientation of the ribbon guide 16, that is, the width direction of the ribbon guide 16 makes an inclination of 90° against the advancing direction on the surface of the paper sheet, so that an error on the surface of the paper sheet can be easily corrected.

That is, when an error is corrected using the dispenser, both the ribbon guide 16 and the refill casing 17 rotate by 360°. Therefore, unlike a correction tape dispenser of the related art, a user can conveniently use the dispenser while a user keeps holding the housing 11 without a cumbersome work such as aligning the direction of the ribbon guide.

In this manner, according to the present invention, there is provided a cylindrical dispenser having a refill casing rotatable by 360° inside the housing 11. Therefore, since the refill casing rotates without an orientation of the cylinder during the use of the dispenser, a user can conveniently use the dispenser at any angle, that is, regardless of the orientation, while a user keeps holding the housing 11.

1. A correction tape dispenser, comprising:
a housing having a dispensing hole in a front end;
a cap coupled to a rear end of the housing; and
a cylindrical refill casing coupled rotatably inside the housing and configured to house a supply rill and a recovery rill meshing with each other using a gear unit, and a ribbon guide for guiding a correction tape,
wherein the refill casing is configured to maintain a certain interval from an inner wall of the housing and is supported by a shaft receptacle provided in a center portion of an inner surface of the cap using a shaft provided in a center of a rear end of the refill casing so as to be rotatable by 360.

2. The correction tape dispenser according to claim 1, wherein the shaft receptacle of the cap includes
a shaft receptacle casing that receives the shaft of the refill casing having a wedge shape and catches the rear end of the shaft, and
a shaft receptacle groove that supports a wedge portion of the shaft and serves as a rotation support point of the shaft during rotation of the refill casing.

3. The correction tape dispenser according to claim 1, wherein a pair of guide holes having a spiral shape are formed around an outer circumferential surface of the housing, and
a pair of guide pins inserted into the guide holes to move along the guide holes are formed on an inner circumferential surface of the cap such that the ribbon guide provided in the front end of the refill casing is retractable into and extractable from the housing as the cap moves forward and backward.

4. The correction tape dispenser according to claim 2, wherein a pair of guide holes having a spiral shape are formed around an outer circumferential surface of the housing, and
a pair of guide pins inserted into the guide holes to move along the guide holes are formed on an inner circumferential surface of the cap such that the ribbon guide provided in the front end of the refill casing is retractable into and extractable from the housing as the cap moves forward and backward.
